(19) United States
(12) Patent Application Publication
(10) Pub. No.: US 2012/0327304 A1
(43) Pub. Date: Dec. 27, 2012

(54) CONTENTS PROCESSING SYSTEM, CONTENTS PROCESSING APPARATUS, AND PROGRAM OF THE APPARATUS

(75) Inventor: Shuntaro KASHI, Osaka (JP)

(73) Assignee: ONKYO CORPORATION, Osaka (JP)

(21) Appl. No.: 13/448,758

(22) Filed: Apr. 17, 2012

(30) Foreign Application Priority Data
Jun. 21, 2011 (JP) 2011-136924

(51) Int. Cl. H04N 5/14

(52) U.S. Cl. 348/707; 348/E05.062

(57) ABSTRACT

Respective room output functions of an AV amplifier are set as respective devices. A controller receives device information about the devices from the AV amplifier, and can recognize the room output functions of the AV amplifier as different devices. As a result, the user can operate the room output functions of the AV amplifier individually through the controller.

### BACKGROUND OF THE INVENTION

1. Field of the Invention

The present invention relates to a contents processing system having a contents processing apparatus with a plurality of room output functions, and a controller for controlling the room output functions of the contents processing apparatus.

2. Description of the Related Art

AV amplifiers have a plurality of audio and video input terminals, and processes audio and video signals input from the input terminals so as to output the processed signals from a plurality of audio output terminals and video output terminals. In recent years, many AV amplifiers have network interfaces (hereinafter, network I/Fs), and process audio and video data input from the network I/Fs so as to output the processed signals from the audio output terminals and the video output terminals.

The AV amplifier having a renderer function as one of network functions transmits its own device information file to a network controller (hereinafter, referred to as a controller) via a network, and notifies presence of the AV amplifier. As a result, the controller recognizes the AV amplifier as a renderer. The AV amplifier is displayed as the renderer on a display device connected to the controller. When a user operates the controller so as to specify a server's contents and an AV amplifier, the AV amplifier reproduces the server's contents.

An AV amplifier, that is compatible with multi-zone output, amplifies an input signal so as to output the signal to a speaker arranged in a main room, and simultaneously can output the input signal from different input terminals to a speaker in a sub-room. For example, the AV amplifier compatible with multi-zone output outputs an input signal from a CD player to a speaker in a main room (hereinafter, referred to as a main zone), and simultaneously receives and processes server's contents data specified by the controller on the network so as to be capable of outputting the processed contents data to a speaker in a sub room (hereinafter, referred to as a sub zone).

Even in a case where the AV amplifier compatible with multi-zone output has a renderer function, since the AV amplifier notifies the controller of the AV amplifier itself being one renderer device, the controller recognizes the AV amplifier as one renderer.

When the user specifies and operates the AV amplifier displayed on the controller, the controller transmits a control packet to the AV amplifier. The AV amplifier that receives the control packet executes a control instruction described in the control packet without discrimination between the main zone and the sub zone. For example, when the controller transmits a control instruction for play stop to the AV amplifier, the AV amplifier stops reception of the contents data from the server. As a result, since all outputs to the main zone and the sub zone are stopped, sounds are not output from all the speakers. That is to say, the user cannot operate different operations in the respective zones from the controller to the AV amplifier.

### SUMMARY OF THE INVENTION

It is an object of the present invention to recognize respective room output functions of a contents processing apparatus individually from a controller on a network so as to enable control.

A contents processing system comprises: a controller; and a contents processing apparatus connectable to the controller via a network. The contents processing apparatus has: a plurality of input sections into which contents are input, a plurality of output sections that is related with a plurality of rooms and outputs the contents to contents receiving apparatuses arranged in the plurality of rooms, an output control section for making control so that the contents are output from the output sections to the contents receiving apparatuses arranged in the rooms, a device setting section for setting device information about respective room output functions as respective devices for outputting the contents from the output sections to the contents receiving apparatuses arranged in the respective rooms, and a device information transmitting section for transmitting one or the plural pieces of the device information set by the device setting section to the controller. The controller has; a device information receiving section for receiving one or the plural pieces of the device information from the contents processing apparatus, a selecting section for selecting devices target for control based on the received device information according to a user's operation, and an instruction transmitting section for transmitting an instruction for controlling the selected device to the contents processing apparatus. The contents processing apparatus further has; an instruction receiving section for receiving the instruction for controlling the selected device from the controller, a specifying section for specifying the room output function corresponding to the selected device, and a processing section for executing an instructed process for the specified room output function.

The respective room output functions of the AV amplifier are defined as respective devices. The controller receives device information about the devices from the AV amplifier, and can recognize the respective room output functions of the AV amplifier as different devices. As a result, a user can operate the room output functions of the AV amplifier individually using the controller.

The device setting section sets the device information about the plurality of room output functions as respective devices. The specifying section specifies the plurality of room output functions corresponding to the selected devices. The processing section executes instructed processes for the specified plurality of room output functions.

The AV amplifier defines devices where a plurality of room output functions is combined arbitrarily, and transmits device information. The devices where the room output functions are combined arbitrarily are displayed on a display section of the controller. As a result, the user operates the controller so as to be capable of making control with combinations of any room output functions in the AV amplifier.

The device information includes a high-order device as a root device and a low-order device positioned in a low-order hierarchy of the root device. The device setting section sets information about control of the room output function corresponding to the high-order device made by the controller in the information about the high-order device in the device information, and sets information about control of the room output function corresponding to the high-order device and the room output function corresponding to the low-order device made by the controller in information about the low-order device in the device information.

When the user selects a low-order device in the controller, a command for controlling both the low-order device and a high-order device related with the low-order device is transmitted to the AV amplifier. As a result, the user can easily select room output functions that are frequently used in the controller, and can clearly recognize low-order room output functions that are added to the high-order device and are controlled so as to enable selection.

The contents processing apparatus further includes: a setting section for setting the room output functions to be valid or invalid respectively; and a setting change section for, when the room output functions specified by the specifying section are set to be invalid, changing the room output functions specified by the specifying section from invalid into valid.

Even when the room output functions controlled by the controller are set invalid, the AV amplifier automatically changes the settings of the room output functions into valid. For this reason, the user can control the room output functions of the AV amplifier from the controller regardless of setting contents of zone output settings in the AV amplifier.

The controller further has a device information display control section for making a display device display a device list based on the received device information. The device information display control section displays the device list having a hierarchical structure composed of one or more devices as the high-order devices and the other devices as the low-order devices with respect to the high-order devices.

Since the high-order device is displayed in a hierarchy higher than the low-order device on the display device of the controller, the user can easily select the room output functions frequently used in the controller, and can clearly recognize and select a low-order room output function that is added to the high-order device and is controlled.

### BRIEF DESCRIPTION OF THE DRAWINGS

FIG. 1 is a constitutional diagram illustrating a network AV system according to preferred embodiments of the present invention;

FIG. 2 is a block diagram illustrating a constitution of an AV amplifier 100 according to the preferred embodiment of the present invention;

FIG. 3 is a zone output setting table;

FIG. 4 is a flowchart where a control section 11 generates DDD:

FIG. 5 is a zone device table 12B;

FIG. 6 is a flowchart where the control section 11 generates the zone device table 12B;

FIG. 7 is a service description 12D;

FIG. 8 is the zone device table 12B;

FIG. 9 is a device model 1;

FIG. 10 is a screen that is displayed on a display section of a controller 200;

FIG. 11 illustrates a template 12C of the device description;

FIG. 12 is a flowchart where the device description is generated;

FIG. 13 illustrates a device description document;

FIG. 14 illustrates a device model 2;

FIG. 15 illustrates a screen displayed on the display section of the controller 200;

FIG. 16 illustrates the template 12C of the device description;

FIG. 17 illustrates the device description document;

FIG. 18 illustrates a reproduction screen displayed on the display section of the controller 200;

FIG. 19 illustrates a control packet received by the AV amplifier 100;

FIG. 20 is a flowchart at a time when the control section 11 receives the control packet;

FIG. 21 is a flowchart where the control section 11 executes an action;

FIG. 22 is a flowchart at the time when the control section 11 receives the control packet; and

FIG. 23 is a flowchart at the time when the control section 11 receives the control packet.

### DETAILED DESCRIPTION OF THE PREFERRED EMBODIMENTS

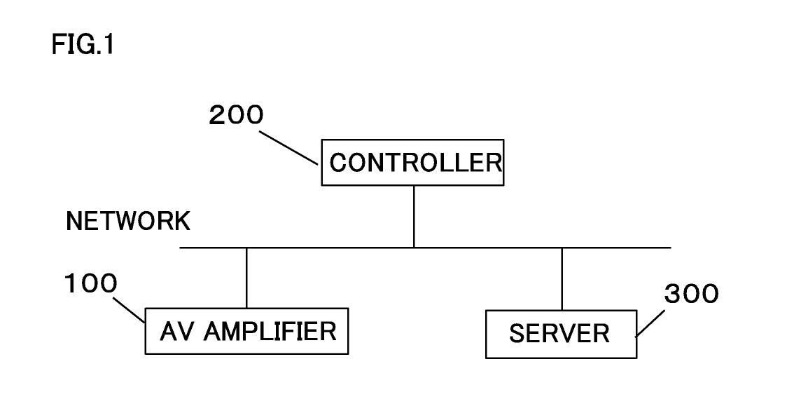

An AV amplifier according to preferred embodiments of the present invention will be concretely described below with reference to the drawings, but the present invention is not limited to the embodiments. FIG. 1 is a constitutional diagram illustrating a contents processing system according to the preferred embodiments of the present invention. The AV amplifier 100 can be connected to a controller 200 and a server 300 via any network such as LAN according to UPnP (Universal Plug and Play) standards.

The controller 200 searches the server 300 on a network, and displays information about the server 300 on a display section connected to the controller 200. The display section of the controller 200 is an LCD display of the controller main body or an externally connected television monitor. The AV amplifier 100 transmits a device information file of itself to the controller 200. Examples of the device information are a device name, a device category, and a device ID and the like. Examples of the device category are a server, a renderer, and a controller, and the device category represents a type of a network device. The controller 200 receives the device information file, and recognizes the AV amplifier 100 as a renderer. The controller 200 acquires contents information in the server 300 so as to display it on the display section. When a user operates the controller 200 and specifies contents in the server 300 and the AV amplifier 100, the controller 200 transmits URL of the contents in the server 300 to the AV amplifier 100. The AV amplifier 100 accesses to URL of the contents of the server 300 received from the controller 200, and acquires and reproduces contents data. The contents include digital data such as music data, still image data and moving image data. The contents as audio data will be described below, and description about video data will be omitted.

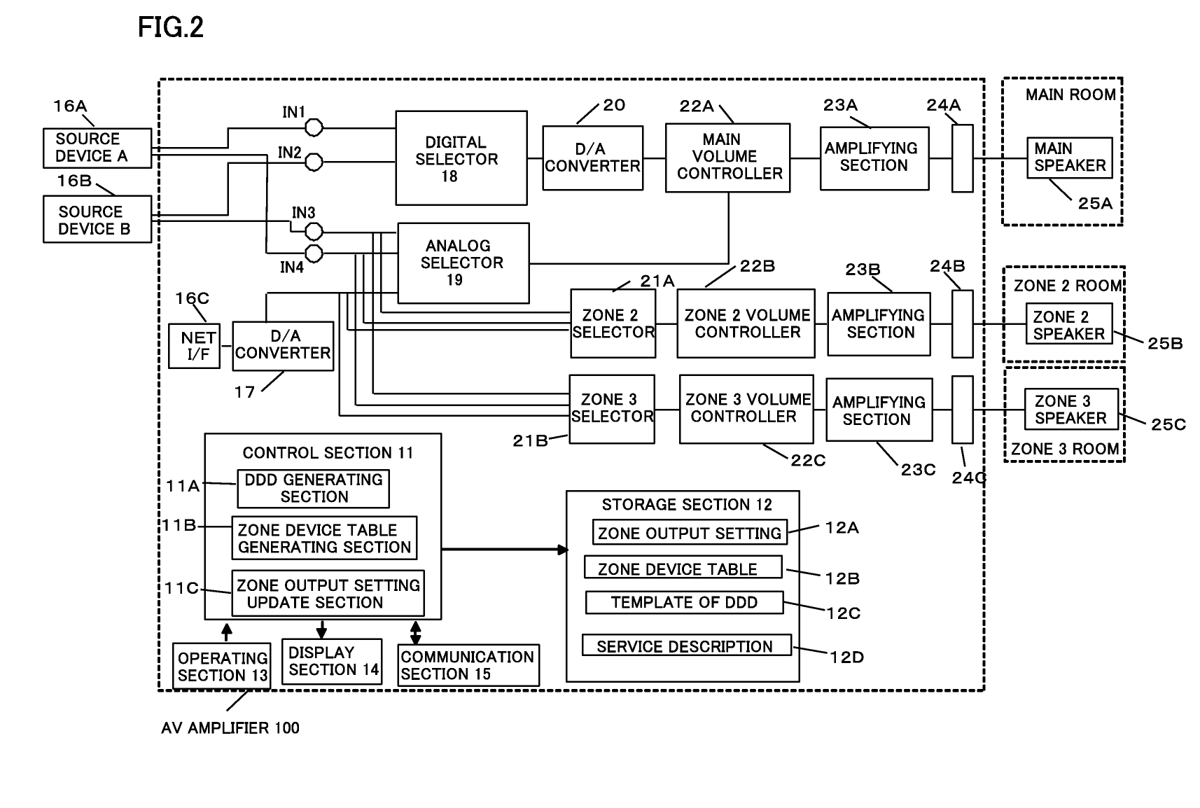

FIG. 2 is a block diagram illustrating a constitution of the AV amplifier 100 according to the preferred embodiments of the present invention. The AV amplifier 100 has a control section 11, a storage section 12, an operating section 13, a display section 14, a communication section 15, a NETI/F16C, a D/A converter 17, a digital selector 18, an analog selector 19, a D/A converter 20, a zone 2 selector 21A, a zone 3 selector 21B, a main volume controller 22A, a zone 2 volume controller 22B, a zone 3 volume controller 22C, amplifying sections 23A, 23B and 23C, speaker output terminals 24A, 24B, and 24C.

A source device 16A and a source device 16B are input devices connected to the AV amplifier 100, and for example, a DVD player or a CD player. A main speaker 25A installed in a main room is connected to the speaker output terminal 24A of the AV amplifier 100, and outputs a supplied audio signal to the outside. A zone 2 speaker 25B installed in the zone 2 room is connected to the output terminal 24B of the AV amplifier 100, and outputs a supplied audio signal. A zone 3 speaker 25C installed in the zone 3 room is connected to the speaker output terminal 24C of the AV amplifier 100, and outputs a supplied audio signal. The number of the zones is not limited to this.

The control section 11 has a device information file (a device description document, hereinafter, referred to as DDD) generating section 11A, a zone device table generating section 11B and a zone output setting update section 11C. DDD is a file in which device information about the renderer is described. The controller 200 analyzes DDD received from the AV amplifier 100, and recognizes details of the renderer. The control section 11 is, for example, a microcomputer or a CPU.

The storage section 12 has a zone output setting 12A, a zone device table1 12B, a template 12C of DDD and service description 12D. The storage section 12 is, for example, a ROM or a flash memory.

The operating section 13 accepts an instruction input by the user. An input section 13 accepts inputs through, for example, a remote controller or buttons arranged on the AV amplifier 100. The input instruction is analyzed and carried out in the control section 11.

The display section 14 is an FL or an LCD display of the AV amplifier 100, or an externally connected TV monitor, and the like. While the AV amplifier 100 is receiving and reproducing contents data from the server 300, the display section 14 displays contents information (for example, an artist name, a music title, and a reproducing time) about the contents that are being reproduced.

The communication section 15 receives communication data from the controller 200 or the server 300 on the network, and transmits the communication data to the controller 200 or the server 300.

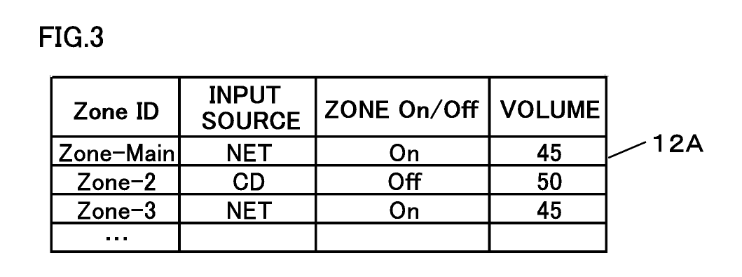

FIG. 3 illustrates the zone output setting 12A. The zone output setting 12A manages a zone ID for identifying a zone, an input source name, on/off setting of zone outputs, a volume value of an audio signal output from zone speaker. For example, as to the zone output setting of the main zone, its input source name is NET, and its on/off setting of the zone output is on. Therefore, the main speaker 25A outputs an audio signal input from the NETI/F16C. As to the output setting of the zone 2, its on/off setting of the zone output is off setting. Therefore, no sound is output from the zone 2 speaker 25B. As to the output setting of the zone 3, since its input source setting is NET, and its on/off setting of the zone output is on setting, an audio signal input from the NETI/F16C is processed and a sound is output from the zone 3 speaker 25C. The zone output setting 12A is displayed on the display section 14, and the user can change a zone output value through the operating section 13 of the AV amplifier 100.

The audio signal input from the NETI/F16C is converted into an analog signal by the D/A converter 17. The control section 11 refers to the zone output setting 12A, and controls an analog selector 19 so that the analog selector 19 selects an audio signal input from a suitable input terminal and outputs it to a next device. For example, in a case of the zone output setting in FIG. 3, the control section 11 makes control so that the audio signal from NET/IF16C is output to the main volume controller 22A.

Similarly to the analog selector 19, the control section 11 makes control so that a zone 2 selector 21A and a zone 3 selector 21B select input audio signals set in the zone output setting 12A and transmit them to a next device. For example, in a case of the zone output setting in FIG. 3, control is made so that the zone 2 selector 21A selects an input audio signal from a CD player connected to the AV amplifier 100, and the zone 3 selector 21B selects an input audio signal from the NET/IF16C and transmits the signal to a next device.

The audio signals selected by the analog selector 19, the zone 2 selector 21A and the zone 3 selector 21B are input into the main volume controller 22A, the zone 2 volume controller 22B, and the zone 3 volume controller 22C. A volume controller sets the audio signals to volume values set in the zone output setting 12A. The audio signals are amplified by the amplifying sections 23A, 23B, and 23C, and are output from the main speaker 25A, the zone 2 speaker 25B and the zone 3 speaker 25C connected to the speaker output terminals 24A, 24B, and 24C, respectively.

The AV amplifier 100 can output audio signals, that are simultaneously input from different input sources, from the main speaker 25A, the zone 2 speaker 25B and the zone 3 speaker 25C installed in different rooms.

The AV amplifier 100 having the above constitution sets the room output functions for outputting contents to contents receiving apparatuses (the speakers 25A to 25C) arranged in the respective rooms (zones) as respective devices, and generates device information (DDD). The AV amplifier 100 transmits DDD to the controller 200. The controller 200 displays a device list on the display section based on the received DDD. When the user selects a desired device to be controlled by the controller 200, the controller 200 transmits an instruction for controlling the device to the AV amplifier 100. The AV amplifier 100 specifies a room output function to be controlled based on the instruction received from the controller 200. The AV amplifier 100 executes a process instructed by the controller 200 for these specified room output function. As a result, the user operates the controller 200 so as to be capable of controlling the room output functions of the AV amplifier 100 individually.

### Generation of Zone Device According to First Embodiment

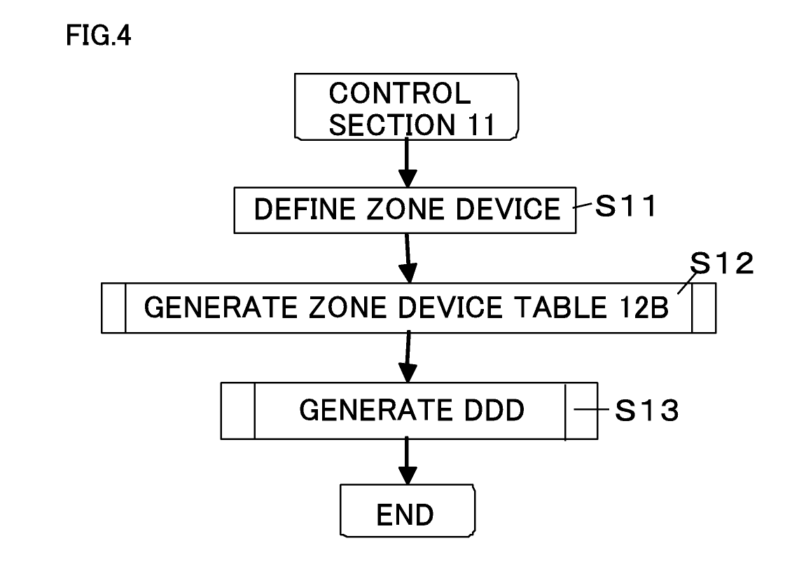

An operation of the present invention will be described below. FIG. 4 is a flowchart for describing generation of DDD by the control section 11 of the AV amplifier 100 according to first and second embodiments.

The control section 11 defines zone devices (S11). The zone devices are renderer devices that are notified to the controller 200 by the AV amplifier 100. For example, when the AV amplifier 100 has three zone output sections, the main zone device, the zone 2 device, and zone 3 device are generated as the zone devices.

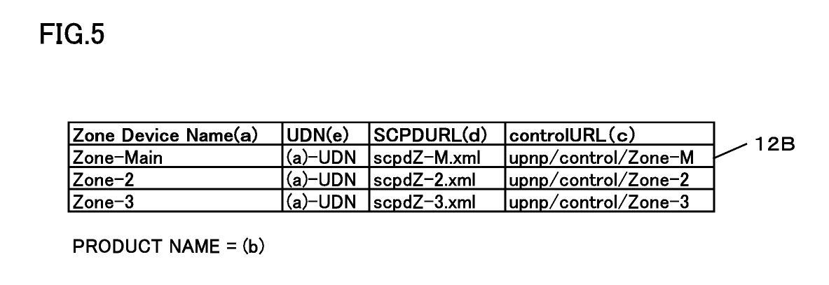

The control section 11 generates the zone device table 12B that manages information about the zone devices (S12). FIG. 5 illustrates the zone device table 12B generated by the control section 11. The zone device table 12B manages zone device names, UDN (identification numbers of the zone devices), SCPDURL (URL of the service description), and Control URLs (URLs of the zone devices) for respective generated zone devices. The details will be described later.

Return to FIG. 4, the control section 11 generates DDD using the zone device table 12B (S13). The generated DDD is transmitted from the AV amplifier 100 to the controller 200, and the respective zone devices of the AV amplifier 100 are recognized as the renderers by the controller 200.

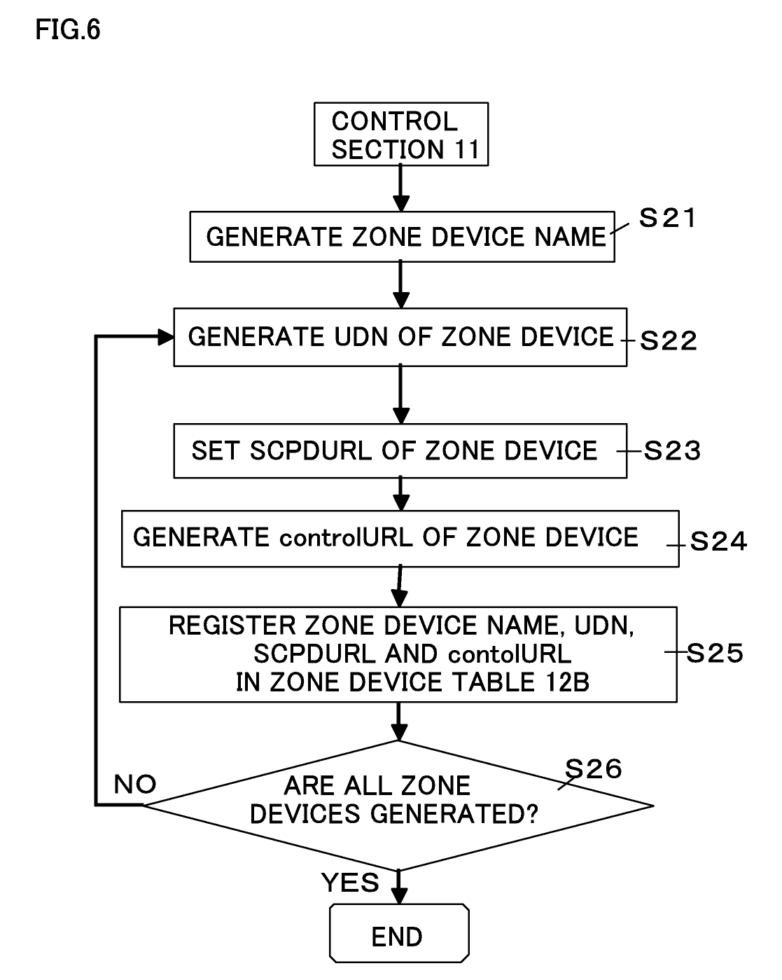

FIG. 6 is a flowchart illustrating a process (S12) of the control section 11 for generating the zone device table 12B. The control section 11 generates zone device names (S21). The zone device names are names for recognizing zone devices. For example, the zone device names of the zone devices defined at S11 are Zone-Main, Zone-2, and Zone-3.

The control section 11 generates UDNs of the zone devices (S22). UDNs are identification numbers of the devices. In general, UDNs are generated based on non-overlapped values of Mac addresses or the like. Since different UDNs should be set for respective zone devices, UDNs of the zone devices to which zone device names are added are generated.

The control section 11 sets SCPDURL of the zone devices (S23). The SCPDURL is location information about the service description 12D. The controller 200 acquires the service description 12D described in SCPDURL from the AV amplifier 100 via the network, and acquires service contents that can be executed by the AV amplifier 100. The AV amplifier 100 may have a plurality of service descriptions 12D. For example, the location information about the service description 12D in which all actions are described is set in SCPDURL of the main zone device, and the location information about the service description 12D in which actions are limited are set in SCPDURL of the zone device only in the sub zone.

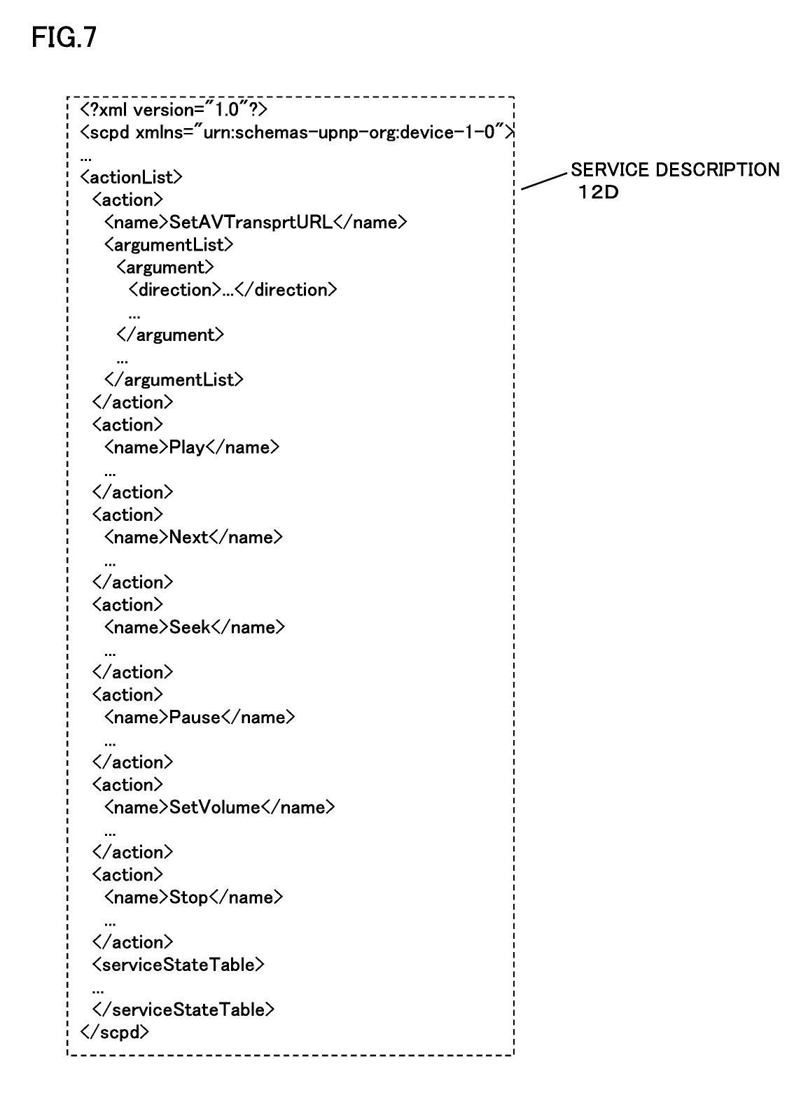

FIG. 7 is a diagram illustrating one example of the service description 12D. The service description 12D is a xml file in which actions executable by the AV amplifier 100 are defined. Actions described between <actionList> and </actionList> are actions that can be executed by the AV amplifier 100. For example, Play, Next, SetVolume, and Stop are described. Notations of parameters and state variables are omitted.

Return to FIG. 6, the control section 11 generates control URLs of the zone devices (S24). The controlURLs are URLs utilized when the controller 200 controls the AV amplifier 100. When the controller 200 controls the AV amplifier 100, a zone device of the AV amplifier 100 that is to be operated is notified to the AV amplifier 100 by describing controlURL into a control packet. The AV amplifier 100 receives controlURL, and determines the zone device requested to be controlled. The controlURL is a format in which zone device names are added to a character string “upnp/contol/”. When the AV amplifier 100 performs a common operation in each zone device, the same controlURL is allocated to the zone devices.

The control section 11 registers zone device names, UDNs, SCPDURLs and controlURLs of the zone devices into the zone device table 12B (S25).

The control section 11 determines whether all the zones in the AV amplifier 100 are defined as the zone devices and are registered into the zone device table 12B (S26). When not all the zone devices in the zones are generated (NO at S26), residual zone device information is generated so as to be registered into the zone device table 12B (S22 to S25). When the determination is made that the information about the zone devices in all the zones is described in the zone device table 12B (YES at S26), the process is ended.

When the control section 11 transmits DDD generated by using the zone device table 12B to the controller 200, the controller 200 recognizes the main zone device, the zone 2 device, and the zone 3 device as different renderers. As a result, the user can operate zone outputs of the AV amplifier 100 individually.

### Generation of Zone Device According to Second Embodiment

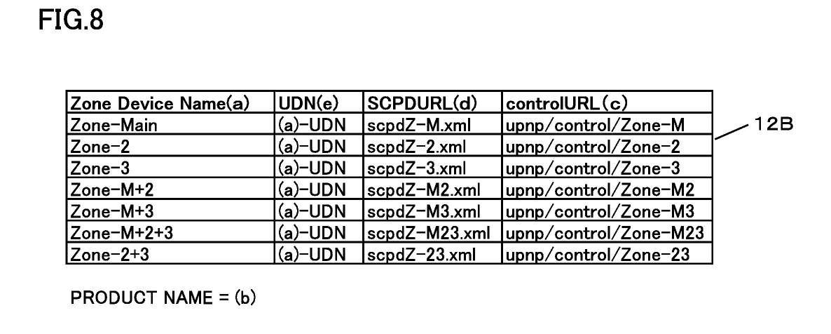

FIG. 8 illustrates the zone device table 12B used in generation of zone devices according to the second embodiment. The zone device table 12B is generated in such a manner that all combinations of the zone output sections of the AV amplifier 100 are defined as zone devices. For example, Zone-M+2 is a zone device obtained by combining the main zone and the zone 2. The zone devices defined in the zone device table 12B are displayed as different renderers on the display section of the controller 200. Since the zone device table 12B in the second embodiment is also generated by the process in the flowchart of FIG. 6, the description thereof is omitted.

For example, when the zone device Zone-M+2 is specified in the controller 200 by the user, the controller 200 transmits the controlURL of the zone device Zone-M+2. The AV amplifier 100 determines controlURL of the received packet, and recognizes that the zone 2 and the main zone are controlled. As a result, the user can control the main zone and the zone 2 of the AV amplifier 100 at the same time.

### Zone Device Model According to First Embodiment

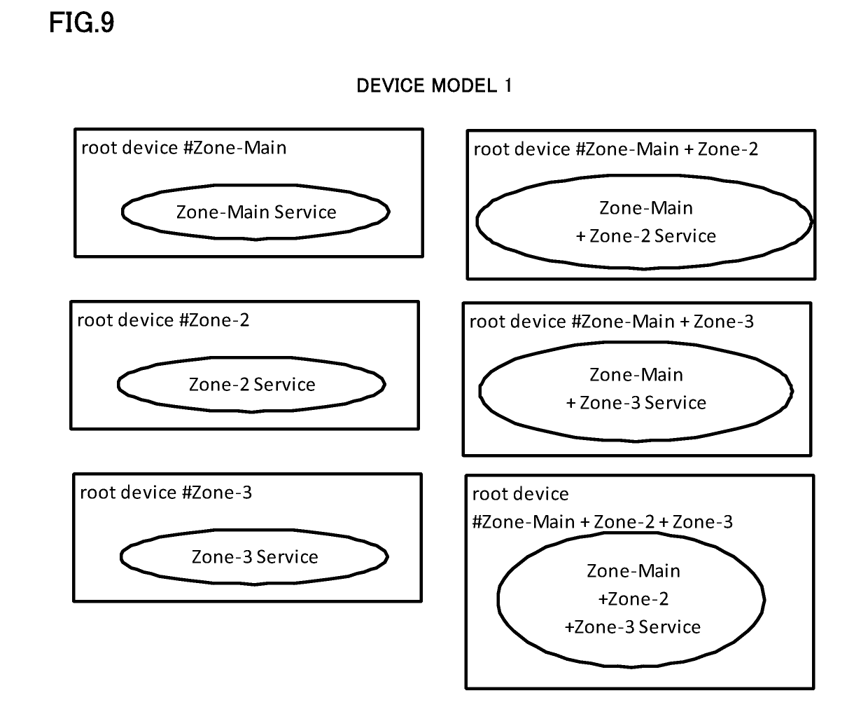

FIG. 9 illustrates a device model to be notified to the controller 200 by the AV amplifier 100 according to the first embodiment (hereinafter, referred to as a device model 1). The device model is a constitution format of the zone device. In the device model 1, six devices including Zone-Main, Zone-2, Zone-3, Zone-Main+Zone-2, Zone-Main+Zone-3, and Zone-Main+Zone-2+Zone-3 are defined as root devices. The respective root devices have services of different contents, respectively. The services are services that are described in the service description 12D.

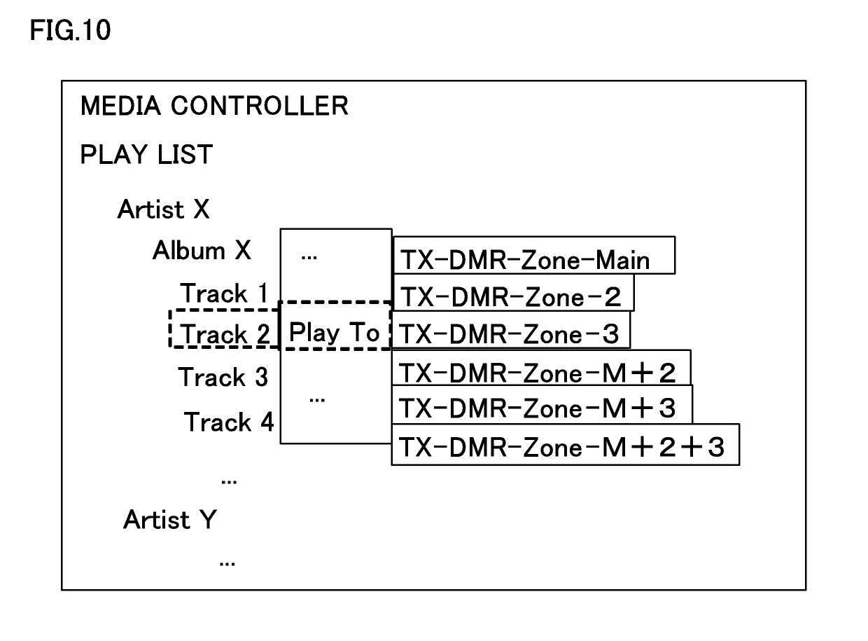

FIG. 10 illustrates a display screen displayed on a control point 200 when this device mode is applied. A contents list of the server 300 is displayed on the display screen of the controller 200. The user selects Track 2 of Album X of Artist X in the server 300, and selects a renderer to be reproduced based on a Play To menu. Play To is a menu for instructing the contents of the server 300 to be reproduced by the renderer displayed on a right side of Play To. When the Play To menu is selected, a list of the zone devices of the AV amplifier 100 is displayed. In the case of the device model 1, since all the zone devices are the root devices, all the zone devices are displayed as top devices.

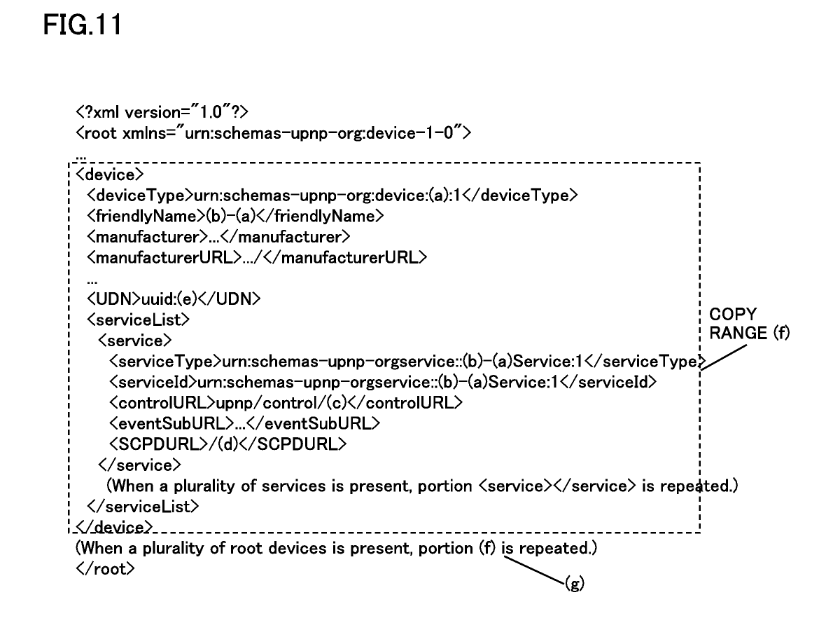

FIG. 11 is a diagram illustrating the DDD template 12C of the device model 1. Portions designated by (a) to (e) of the DDD template 12C correspond to (a) to (e) of the zone device table 12B. The symbol (a) represents a zone device name, the symbol (b) represents a product name (a product name of the AV amplifier), (c) represents controlURL, (d) represents SCPDURL, and (e) represents UDN of a zone device.

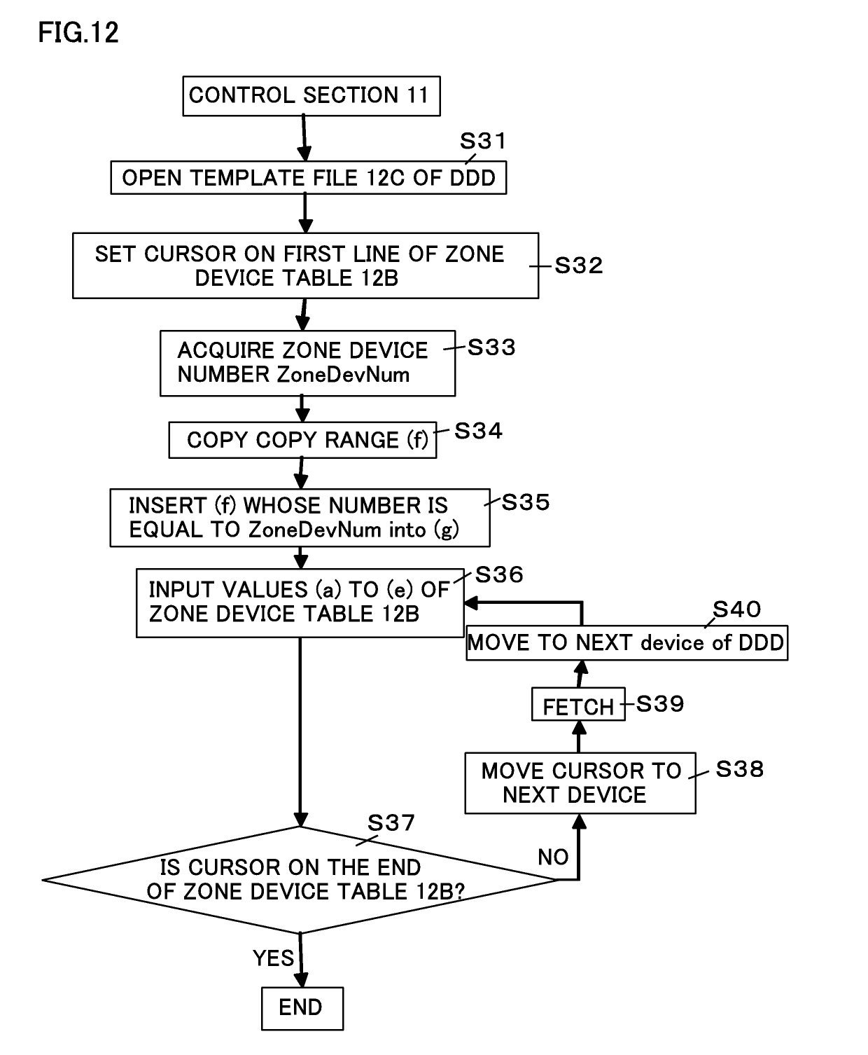

FIG. 12 is a flowchart where the control section 11 generates DDD based on the DDD template 12C. The control section 11 opens the DDD template 12C (S31).

The control section 11 sets a cursor on a first line of the zone device table 12B (S32). The cursor is a data element indicating a line in a database that is currently operated.

The control section 11 acquires the number of zone devices of the zone device table 12B, and stores the number in ZoneDevNum (S33).

The control section 11 copies portions (<device> through </device>) described as (f) in the DDD template 12C (S34), and inserts the number in ZoneDevNum into a position where (g) of the DDD template 12C is described (S35). With such a process, the DDD template 12C having root devices whose number is the same as the zone devices is generated.

The control section 11 applies values of (a) to (e) described in the zone device table 12B to portions with the same symbols as those in the DDD template 12C (S36).

The control section 11 determines whether the cursor indicates the end of the zone device table 12B (S37). When the determination is made that the cursor does not indicate the end of the zone device table 12B (NO at S37), the control section 11 moves the cursor to a next line (S38). The control section 11 fetches data on the line indicated by the cursor (S39).

The control section 11 moves to a next device tag described in the DDD template 12C (S40), and replaces (a) through (e) of the DDD template 12C by the values of (a) through (e) described in the zone device table 12B (S36). When the determination is made that the cursor indicates the end of the zone device table 12B (YES at S37), the process is ended.

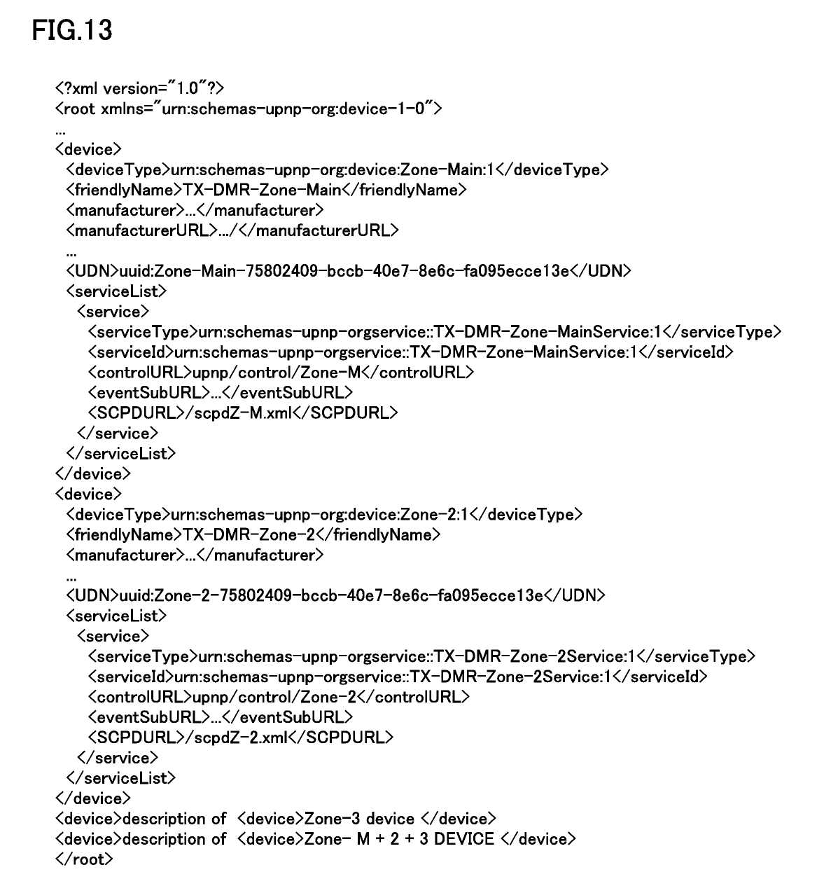

With such a process, DDD of the device model 1 is generated based on the DDD template 12C. FIG. 13 illustrates DDD to be generated. In DDD of FIG. 13, description of the zone devices of Zone-3 and Zone-M+2+3 is omitted. The AV amplifier 100 may store the generated DDD in the storage section 12 in advance.

### Zone Device Model According to Second Embodiment

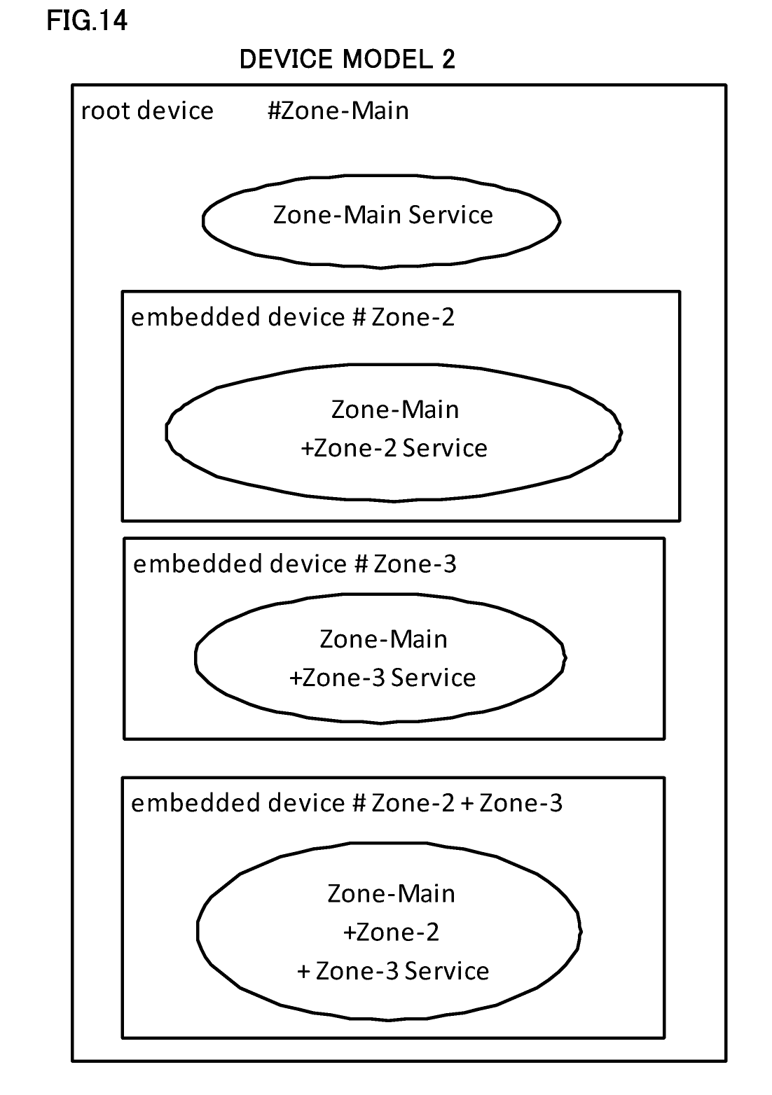

FIG. 14 illustrates a device model according to a second embodiment (hereinafter, referred to as a device model 2). In the device model 2, the zone device only in the main zone is defined as a root device. Devices including the sub zones such as the zone 2 and the zone 3 are defined as low-order devices (hereinafter, referred to as embedded devices) of the main zone.

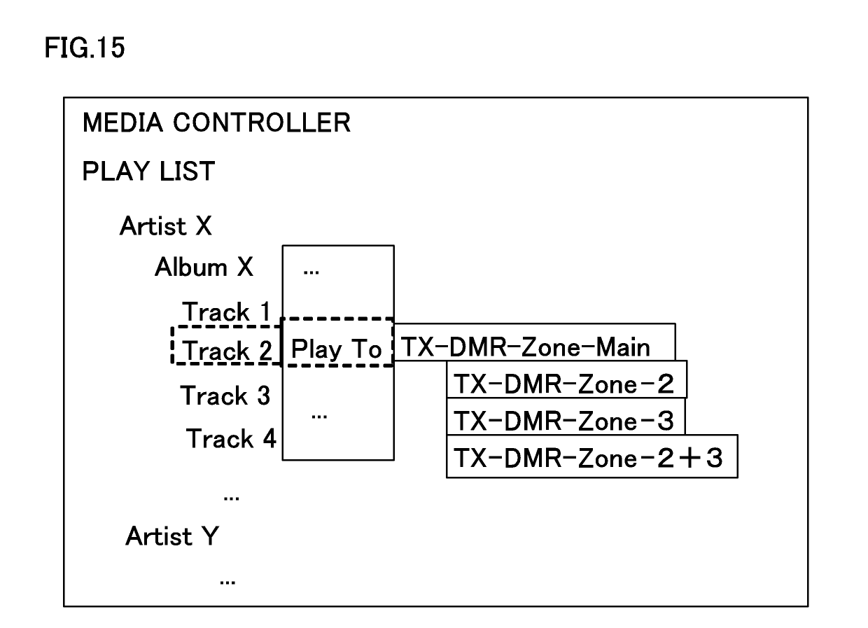

FIG. 15 illustrates a screen displayed on the display section of the controller 200 when the AV amplifier 100 notifies the controller 200 of DDD of the device model 2. The main zone device (TX-DMR-Zone-Main) is displayed as the high-order device on the display section of the controller 200, and the zone devices including the sub zones are displayed as the low-order devices of the main zone device on the display section of the controller 200. When the user selects TX-DMR-Zone-Main, TX-DMR-Zone-2, TX-DMR-Zone-3, and TX-DMR-Zone-2+3 are displayed as the low-order devices. For example, when the user selects TX-DMR-Zone-Main, only the main zone output section of the AV amplifier 100 is a target to be controlled, and when the user selects TX-DMR-Zone-2, the main zone and the zone 2 are targets to be controlled.

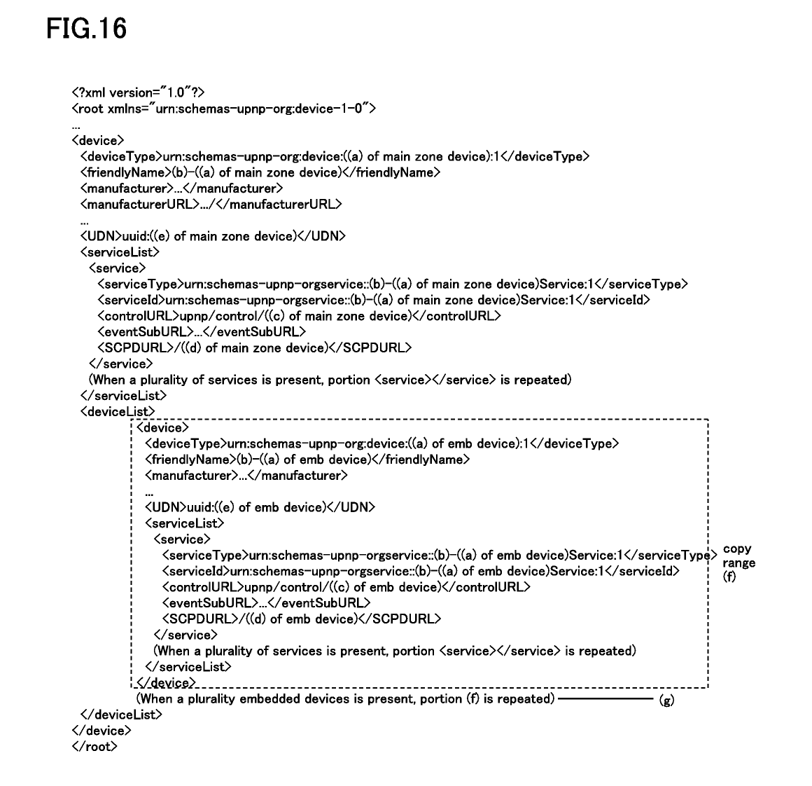

FIG. 16 illustrates the DDD template 12C of the device model 2. Devices described in <device> on the outermost side through </device> in the DDD template of the device model 2 are root devices, and information about the main zone device is described. <deviceList> for describing embedded devices is defined in the main zone device. Information about the embedded devices defined as the low-order devices is described in <deviceList> through </deviceList>.

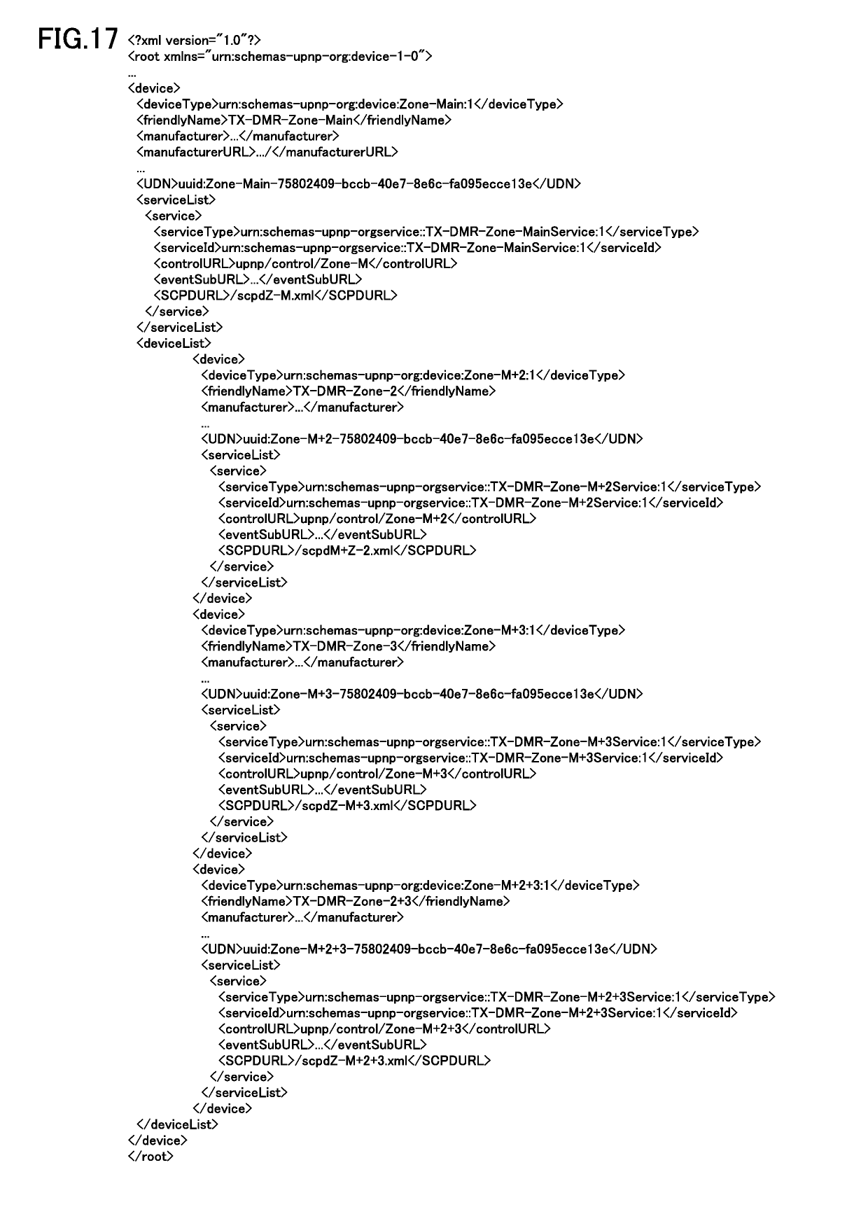

Since also a process for generating DDD of the device model 2 complies with the flowchart in FIG. 12, description thereof is omitted. FIG. 17 illustrates DDD of the device model 2 generated based on the DDD template 12C. According to this embodiment, when the user desires a sound output from the speaker 25A of the main room, the user can clearly recognize a sub zone as well as the main zone from which a sound is output, and can easily set the sub zone. Since the main zone is used by the user most frequently, it is effective that the main zone device is displayed on a top hierarchy in the controller 200.

As a modified example of the device model, the following device model may be defined. In this device model, the zone 2 device or the zone 3 device is defined as the root device, and the main zone device is defined as an embedded device of the zone 2 device or the zone 3 device in the device model 2. Further, all the zone devices may be described in one DDD. Further, a device model in which an embedded device further includes an embedded device may be defined. A plurality of device model candidates is displayed on the display section 14 of the AV amplifier 100, and the user may select a device model to be used via the operating section 13 of the AV amplifier 100.

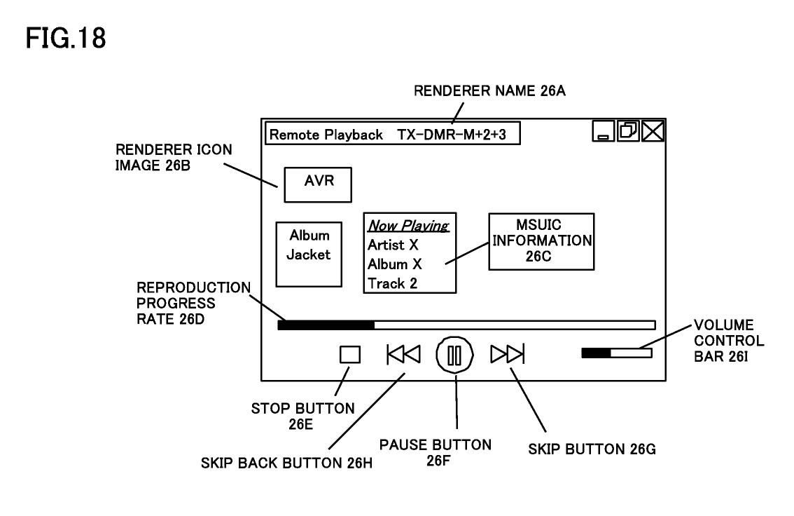

FIG. 18 illustrates a screen displayed on the display section of the controller 200 when the user selects a device displayed on the screen in FIG. 10 or FIG. 15. Hereinafter, this screen is referred to as a RemotePlayback screen. A renderer name 26A, an icon image 26B of the renderer, contents information 26C about contents being reproduced by the renderer, a reproduction progress bar 26D, a stop button 26E, a pause button 26F, a skip button 26G, a skip back button 26H, a volume control bar 261 and the like that are specified by the user are displayed on the RemotePlayback screen. The pause button 26F is the pause button during reproduction, and is switched into display of a reproduction button during stop or pause. As the renderer name 26A, friendlyName tag value of DDD is displayed. The icon image 26B of the renderer is acquired in a manner that the controller 200 requests the AV amplifier 100. The reproduction progress bar 26D and the like is displayed by using information notified from the AV amplifier 100 to the controller 200.

### Reception of Control Packet According to First Embodiment

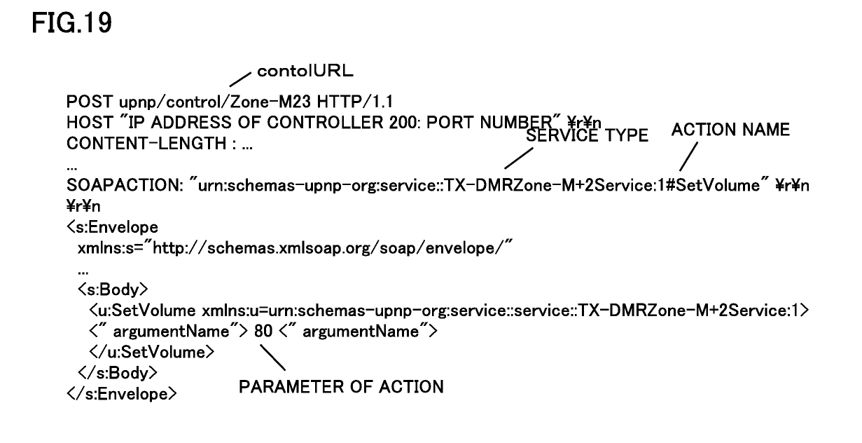

FIG. 19 illustrates contents of a control packet transmitted to the AV amplifier 100 by the controller 200 when the user operates the controller 200. The control packet in FIG. 19 is transmitted from the controller 200 to the AV amplifier 100 when the controller 200 makes control so that the volume of the AV amplifier 100 is changed into 80. The controlURL of the AV amplifier 100 is described on a line where POST is described. A type and an action name of a service is described on a line where SOAPACTION is described. The controller 200 acquires the service type, the action name and the like from the service description and DDD transmitted by the AV amplifier 100, and inserts them into the control packet.

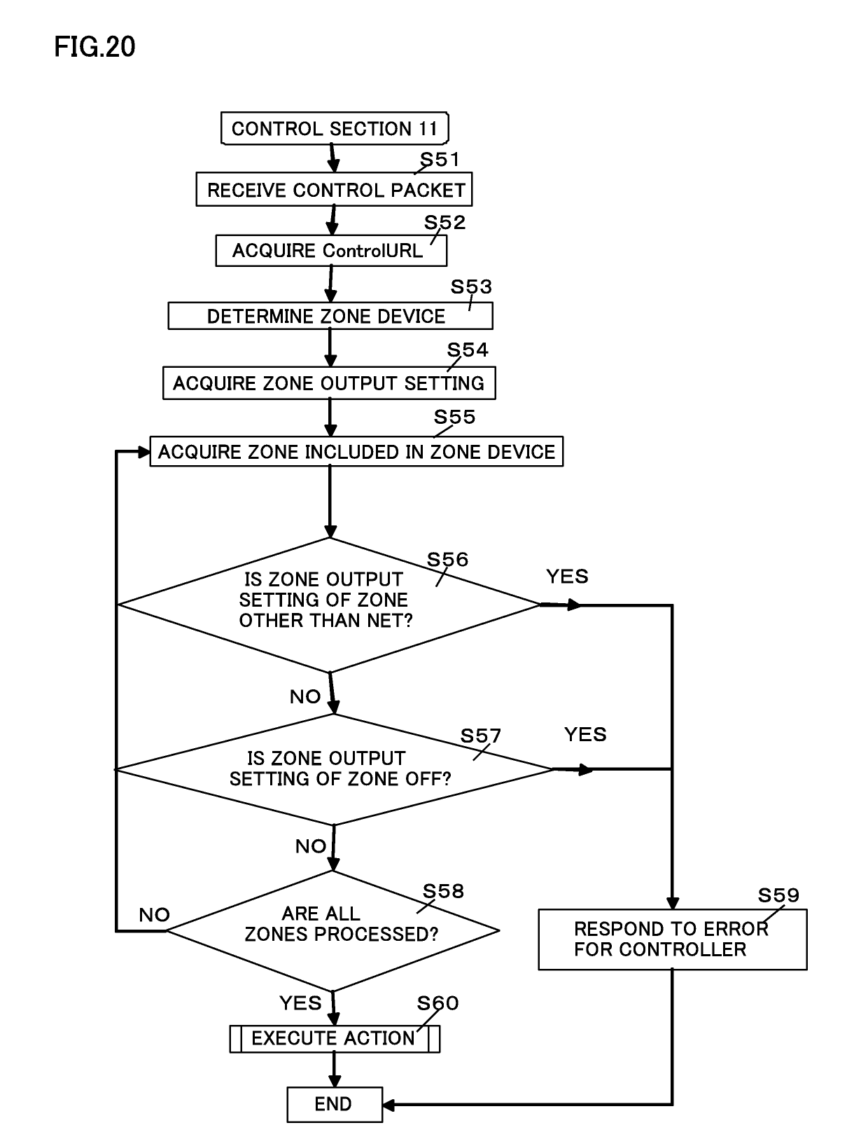

FIG. 20 is a flowchart when the AV amplifier 100 receives the control packet from the controller 200. The control section 11 receives the control packet from the controller 200 (S51).

The control section 11 acquires the controlURL described in the control packet (S52). The control section 11 refers to the zone device table 12B so as to determine the zone device having the zone device name matching with a character string after “/upnp/control/” of the received controlURL name (S53).

The control section 11 refers to the zone output setting 12A of the storage section 12 so as to acquire the zone output setting (S54).

The control section 11 acquires a zone included in the zone device (S55). For example, when the AV amplifier 100 receives the control packet in FIG. 19, the zone device is determined as Zone-M+2+3 by the process at S53, and a determination is made that the main zone, the zone 2, and the zone 3 are included in the zone device.

The control section 11 determines whether input source setting of the zone is other than NET (S56). For example, in the zone output setting of FIG. 3, since the input source setting of the main zone is NET, the determination is made as NO (NO at S56).

The control section 11 determines whether the zone output on/off settings of the zones are off (S57). For example, since the zone output on/off setting of the main zone is on, the determination is made as NO (NO at S57).

The control section 11 determines whether all zones included in the zone device are processed (S58). When the determination is made that not all the zones are processed (NO at S58), the process is executed on a next zone (S55). For example, in the zone output setting of FIG. 3, since input source setting of Zone-2 is CD, the determination is made as YES at S56. In this case, the AV amplifier 100 transmits an error to the controller 200 (S59), and the process is ended. Also when the output on/off setting of the zone is off (YES at S57), the control section 11 transmits the error to the controller 200 (S59), and the process is ended. When the controller 200 receives the error from the AV amplifier 100, a RemotePlayback screen shows that the error occurs in execution of the action.

When the control section 11 determines that steps S56 and S57 are executed on all the zones (YES at S58), the control section 11 executes the action described in the control packet received from the controller 200 (S60).

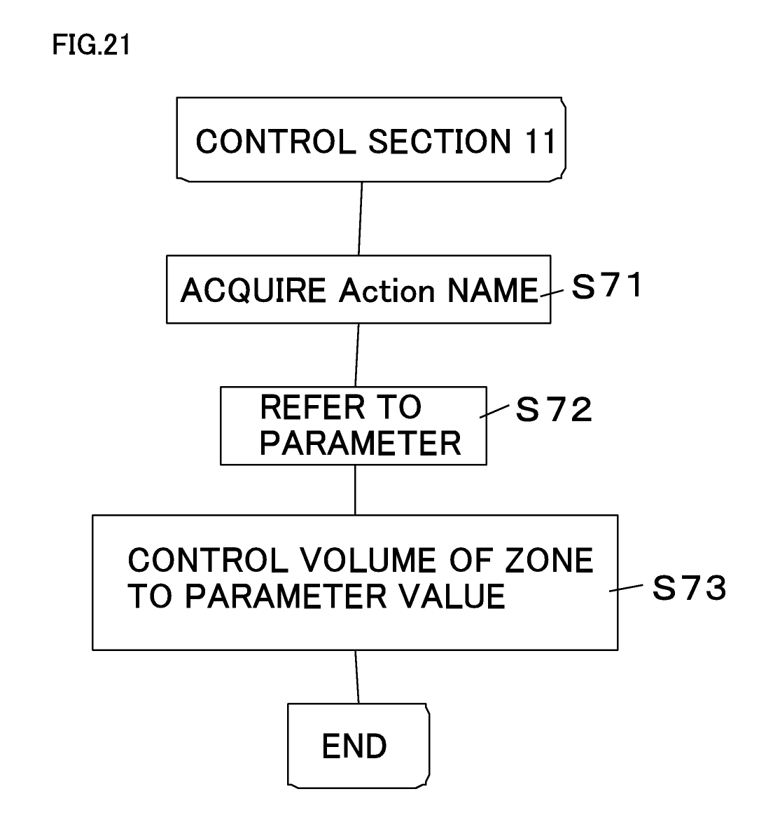

FIG. 21 is a flowchart where the control section 11 executes the action. FIG. 21 illustrates an example when a volume changing action is received. The control section 11 refers to the control packet, and acquires the action name (S71). The action name is SetVolume.

The control section 11 acquires a parameter value described in the control packet (S72). In a case of the control packet in FIG. 19, 80 is the parameter value.

The control section 11 controls the volume setting of the volume controller to the parameter value. For example, when the zone device includes the main zone, the zone 2 and the zone 3, the control section 11 controls the main volume controller 22A, the zone 2 volume controller 22B, and the zone 3 volume controller 22C so that their volume values are changed into 80.

According to this embodiment, when the zone device determined based on the controlURL received from the controller 200 includes a zone whose input source setting is other than NET or whose zone output on/off setting is off, the AV amplifier 100 does not execute the action, and determines as an error. As a result, when the AV amplifier 100 receives a control command of a zone that is not desired to be operated through the controller 200 by the user, an operation unexpected by the user can be prevented from being executed in the AV amplifier 100.

### Reception of Control Packet According to Second Embodiment

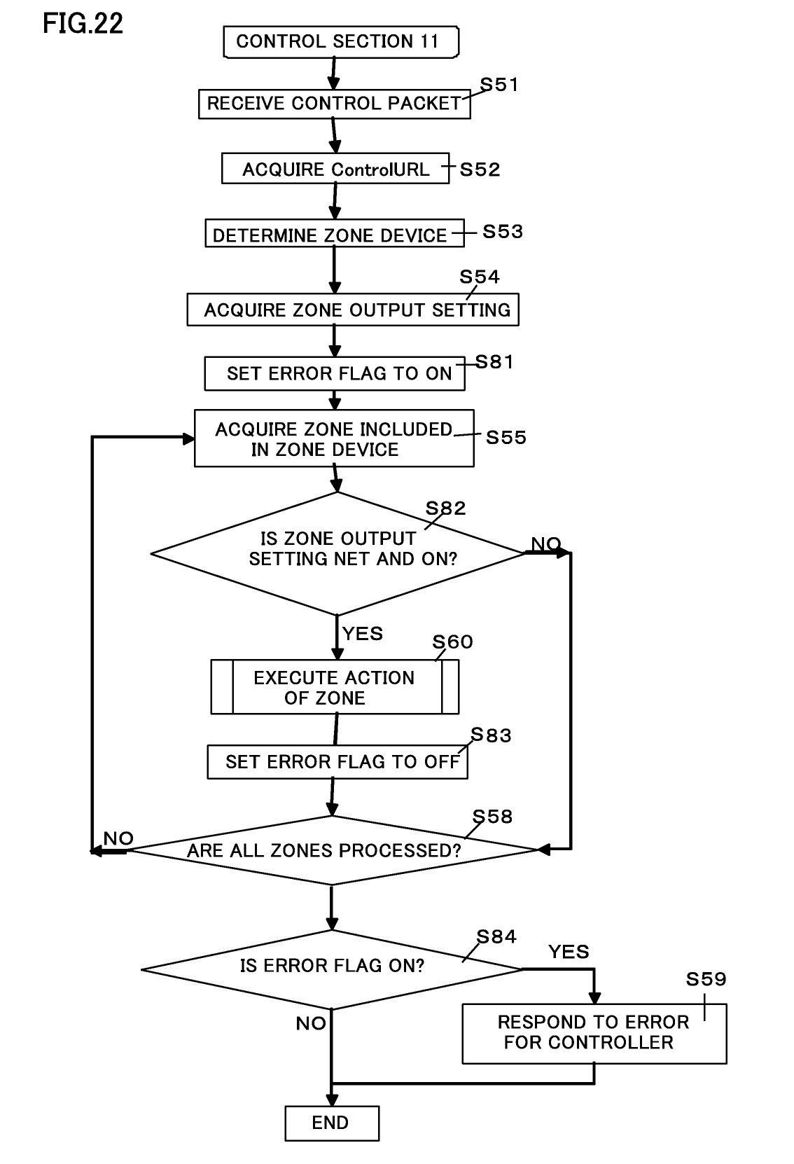

FIG. 22 is a flowchart when the AV amplifier 100 receives the control packet from the controller 200 according to the second embodiment. The same processes as those in FIG. 20 are denoted by the same symbols, and the description thereof is omitted. The control section 11 refers to the zone output setting 12A, and acquires the zone output setting set in the AV amplifier 100 (S54).

The control section 11 sets an error flag to on (S81). The error flag is a flag of 1 bit. The control section 11 acquires a zone included in the zone device (S55).

The control section 11 refers to the zone output setting 12A so as to determine whether the input source setting of the zone is NET and the zone output on/off setting is the on setting (S82). When the determination is made that the input source setting of the zone is NET and the zone output on/off setting is the on setting (YES at S82), the control section 11 executes an action for the zone (S60). The control section 11 sets the error flag to off (S83). When the determination is made that the input source setting of the zone output setting 12A is not NET or the zone output on/off setting is not the on setting (NO at S82), the control section 11 determines whether steps S82, S60 and S83 are executed for all the zones included in the zone device (S58).

When the control section 11 determines that steps S82, S60 and S83 are executed for not all the zones (NO at S58), the similar steps are executed for a next zone (S55). When the determination is made that steps S82, S60 and S83 are executed for all the zones included in the zone device (YES at S58), the control section 11 determines whether the error flag is on (S84). When the determination is made that the error flag is on (YES at S84), the control section 11 notifies the controller 200 of the error (S59). When the determination is made that the error flag is not on (NO at S84), the process is ended.

According to this embodiment, the AV amplifier 100 executes the action for only the zones included in the zone device whose input source setting is NET and whose zone output on/off setting is the on setting. As a result, the user can control only the zone output sections, from which a signal input from the NETI/F16C is desired to be output by the user, using the controller 200.

### Reception of Control Packet According to Third Embodiment

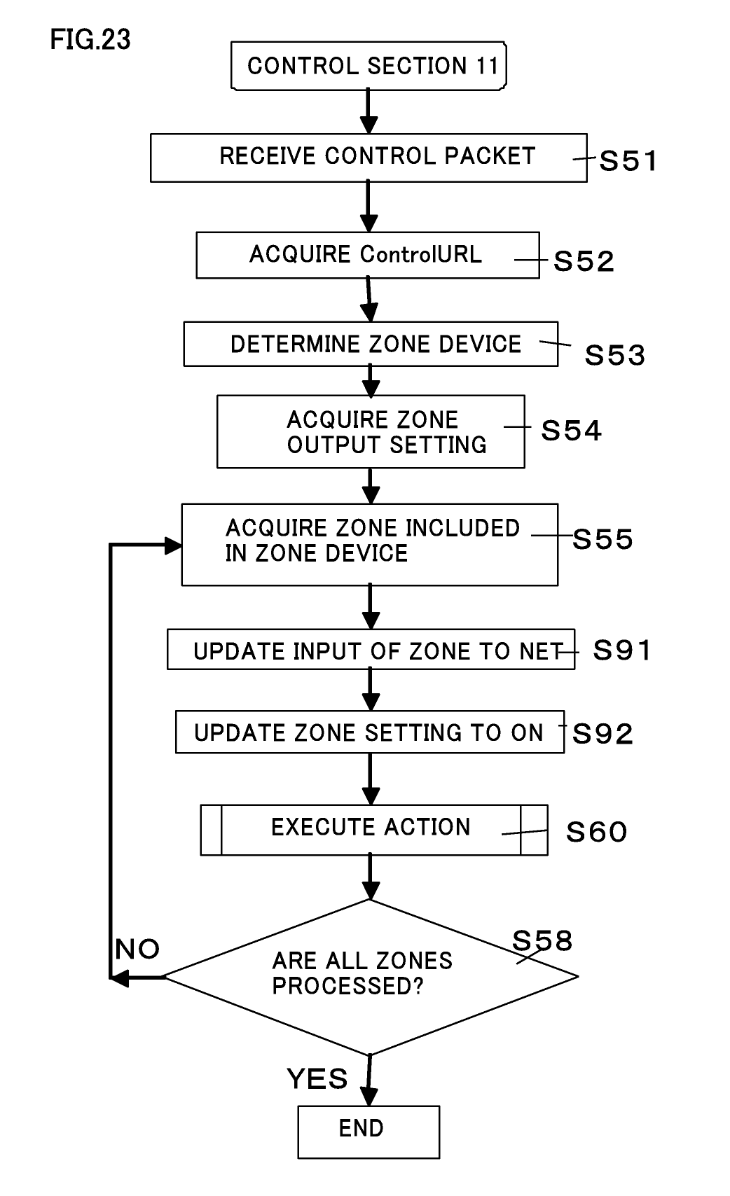

FIG. 23 is a flowchart according to a third embodiment. The same processes as those in FIG. 20 are denoted by the same reference symbols, and the description thereof is omitted. The control section 11 acquires a zone included in the zone device (S55).

The control section 11 updates the input source setting of the zone in the zone output setting 12A to NET (S91).

The control section 11 updates the zone output on/off setting in the zone output setting 12A to the on setting (S92). The control section 11 executes an action (S60). The control section 11 determines whether steps S91, S92 and S60 are executed for all the zones included in the zone device (S58), and when determines that these steps are not executed (NO at S58), the same steps are executed for a next zone (S55). When the determination is made that the steps are executed for all the zones (YES at S58), the process is ended.

According to the third embodiment, the user can perform the operation on all the zones included in the zone device specified by the controller 200 regardless of the zone output setting 12A of the AV amplifier 100.

The above describes the preferred embodiments of the present invention, but the present invention is not limited to these embodiments. A signal input/output to/from the AV amplifier 100 is not limited to an audio signal. That is to say, moving image data or still image data may be employed. Different zone devices may be specified from the PlayTo menu of the controller 200 at a plurality of times, and the operation may be performed. The AV amplifier 100 does not have to have the amplifying section. In this case, an output audio signal is output from a pre-out terminal, not shown in FIG. 2, and is transmitted to an amplifying device (a power amplifier or the like) connected to the outside of the AV amplifier 100.

What is claimed is:

1. A contents processing system, comprising:
a controller; and
a contents processing apparatus connectable to the controller via a network, wherein
the contents processing apparatus has;
a plurality of input sections into which contents are input,
a plurality of output sections that is related with a plurality of rooms and outputs the contents to contents receiving apparatuses arranged in the plurality of rooms,
an output control section for making control so that the contents are output from the output sections to the contents receiving apparatuses arranged in the rooms,
a device setting section for setting device information about respective room output functions as respective devices for outputting the contents from the output sections to the contents receiving apparatuses arranged in the respective rooms, and
a device information transmitting section for transmitting one or the plural pieces of the device information set by the device setting section to the controller,
the controller has;
a device information receiving section for receiving one or the plural pieces of the device information from the contents processing apparatus,
a selecting section for selecting devices target for control based on the received device information according to a user's operation, and
an instruction transmitting section for transmitting an instruction for controlling the selected device to the contents processing apparatus,
the contents processing apparatus further has;
an instruction receiving section for receiving the instruction for controlling the selected device from the controller,
a specifying section for specifying the room output function corresponding to the selected device, and
a processing section for executing an instructed process for the specified room output function.

2. The contents processing system according to claim 1, wherein
the device setting section sets the device information about the plurality of room output functions as respective devices,
the specifying section specifies the plurality of room output functions corresponding to the selected devices,
the processing section executes instructed processes for the specified plurality of room output functions.

3. The contents processing system according to claim 2, wherein
the device information includes a high-order device as a root device and a low-order device positioned in a low-order hierarchy of the root device,
the device setting section sets information about control of the room output function corresponding to the high-order device made by the controller in the information about the high-order device in the device information, and sets information about control of the room output function corresponding to the high-order device and the room output function corresponding to the low-order device made by the controller in information about the low-order device in the device information.

4. The contents processing system according to claim 1, wherein
the contents processing apparatus further includes:
a setting section for setting the room output functions to be valid or invalid respectively; and
a setting change section for, when the room output functions specified by the specifying section are set to be invalid, changing the room output functions specified by the specifying section from invalid into valid.

5. The contents processing system according to claim 1, wherein
the controller further has a device information display control section for making a display device display a device list based on the received device information,
the device information display control section displays the device list having a hierarchical structure composed of one or more devices as the high-order devices and the other devices as the low-order devices with respect to the high-order devices.

6. A contents processing apparatus connectable to a controller via a network, comprising:
a plurality of input sections into which contents are input;
a plurality of output sections that is related with a plurality of rooms and outputs the contents to contents receiving apparatuses arranged in the plurality of rooms;
an output control section for making control so that the contents are output from the output sections to the contents receiving apparatuses arranged in the rooms;
a device setting section for setting device information about respective room output functions as respective devices for outputting the contents from the output sections to the contents receiving apparatuses arranged in the respective rooms;
a device information transmitting section for transmitting one or the plural pieces of the device information set by the device setting section to the controller;
an instruction receiving section for receiving an instruction for controlling the selected device from the controller;
a specifying section for specifying the room output function corresponding to the selected device; and
a processing section for executing an instructed process for the specified room output functions.

7. The contents processing apparatus according to claim 6, wherein
the device setting section sets the device information about the plurality of room output functions as respective devices,
the specifying section specifies the plurality of room output functions corresponding to the selected devices,
the processing section executes instructed processes for the specified plurality of room output functions.

8. The contents processing apparatus according to claim 7, wherein
the device information includes a high-order device as a root device and a low-order device positioned in a low-order hierarchy of the root device,
the device setting section sets information about control of the room output function corresponding to the high-order device made by the controller in the information about the high-order device in the device information, and sets information about control of the room output function corresponding to the high-order device and the room output function corresponding to the low-order device made by the controller in information about the low-order device in the device information.

9. The contents processing apparatus according to claim 6, wherein
the contents processing apparatus further includes:
a setting section for setting the room output functions to be valid or invalid respectively; and
a setting change section for, when the room output functions specified by the specifying section are set to be invalid, changing the room output functions specified by the specifying section from invalid into valid.

10. A contents processing program stored on a non-transitory computer readable medium causing a computer of a contents processing apparatus, wherein the contents processing apparatus is connectable to a controller via a network and comprises a plurality of input sections into which contents are input and a plurality of output sections that is related with a plurality of rooms and outputs the contents to contents receiving apparatuses arranged in the plurality of rooms; to perform;
an output control step for making control so that the contents are output from the output sections to the contents receiving apparatuses arranged in the rooms;
a device setting step for setting device information about respective room output functions as respective devices for outputting the contents from the output sections to the contents receiving apparatuses arranged in the respective rooms;
a device information transmitting step for transmitting one or the plural pieces of the device information set by the device setting step to the controller;
an instruction receiving step for receiving an instruction for controlling the selected device from the controller;
a specifying step for specifying the room output function corresponding to the selected device; and
a processing step for executing an instructed process for the specified room output functions.
